(19) United States
(12) Patent Application Publication
(10) Pub. No.: US 2014/0184387 A1
(43) Pub. Date: Jul. 3, 2014

(54) METHODS AND APPARATUS FOR LUGGAGE TRACKING AND IDENTIFICATION USING RFID TECHNOLOGY

(71) Applicant: Jaroslav Svec, Levice (SK)

(72) Inventor: Jaroslav Svec, Levice (SK)

(21) Appl. No.: 14/137,429

(22) Filed: Dec. 20, 2013

Related U.S. Application Data
(60) Provisional application No. 61/746,830, filed on Dec. 28, 2012.

(51) Int. Cl. G06K 7/10

(52) U.S. Cl. CPC G06K 7/10366
USPC 340/8.1

(57) ABSTRACT

Methods and apparatus for tracking and identifying luggage include an RFID or other wireless device that can be attached or inserted into a piece of luggage. The RFID device may have a unique identifier that is associated with personal identifying information of an owner of the RFID device. Such personal identifying information as well as other information regarding the owner's itinerary may be stored in a database. When RFID readers at airports and other locations scan an RFID device to determine its unique identifier, the database is updated to reflect a location of the RFID device on the piece of luggage. Upon request, the database provides information regarding the location of the RFID device and thus the piece of luggage.

### FIELD OF THE DISCLOSURE

The present description relates generally to luggage logistics and, more particularly, to methods and apparatus for tracking and identifying luggage using RFID technology.

### BACKGROUND OF RELATED ART

Luggage identifiers are known in the art. For years, airlines and transportation providers in other travel sectors have been attaching printed labels to travelers' luggage. These printed labels typically have a bar code that can be scanned by bar code readers. The bar code, which is unique to each piece of luggage, is associated with a record containing information relevant to the owner of the piece of luggage. Such information may include the owner's name and contact information, one or more flight numbers, departure airport, connecting airport(s), arrival airport, and so on. Printed labels attached to luggage may be scanned at various times during a trip to inform airline and airport personnel where a particular piece of luggage is located and/or destined.

The problem with such printed labels, though, is that they must be printed and attached before each flight, and detached and disposed after each flight. This practice of issuing new printed labels for each flight is wasteful, both economically and environmentally. Furthermore, having to issue and attach printed labels to each traveler's checked bags adds time to the check-in process that occurs when travelers arrive at their departure airport. Still further, printed labels are prone to tearing and sticking to luggage. Printed labels also hinder the efficiency of personnel that handle luggage, as those personnel must be careful not to damage the printed label while grabbing the luggage by its handle, where the printed label is most often secured.

Therefore, methods and apparatus are needed that solve the aforementioned problems and improve the state of identifiers for checked luggage.

### BRIEF DESCRIPTION OF THE FIGURES

FIG. 1 is a schematic representation of an example system for tracking and identifying luggage.

FIG. 2 is a flowchart of an example method of using the example system disclosed with respect to FIG. 1.

### DETAILED DESCRIPTION

The following description of example methods and apparatus is not intended to limit the scope of the description to the precise form or forms detailed herein. Instead the following description is intended to be illustrative so that others may follow its teachings.

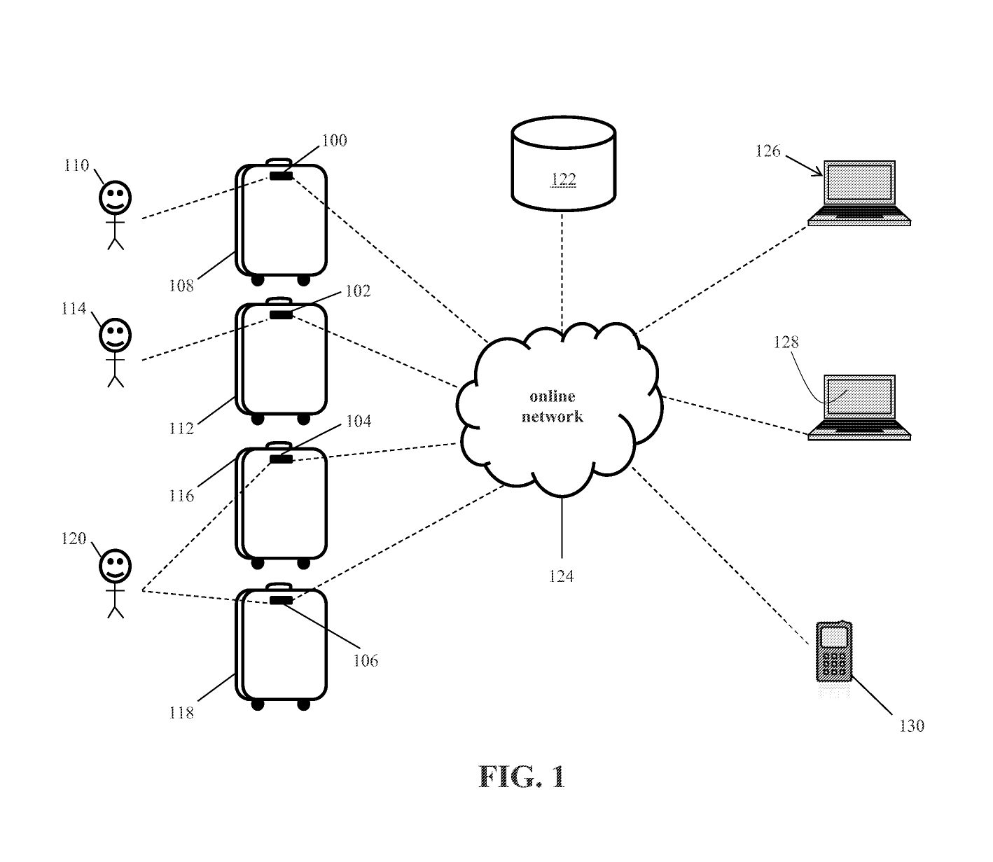

The present disclosure is directed toward a method of tracking and identifying luggage using radio frequency identification (RFID) technology. It will be appreciated by one of ordinary skill in the art that while the present examples are described in relation to an RFID technology, any known and/or suitable device/technology, such as, for example, near field communication (NFC) may be utilized as desired. In particular, the disclosed method utilizes an RFID chip, which may be embedded into a token, ticket, card, and/or tag (referred to herein as the “RFID Device”), such as RFID Devices 100, 102, 104, or 106 shown in FIG. 1, which may be removably inserted into a user's luggage, such as a piece of luggage 108 owned by a user 110, a piece of luggage 112 owned by a user 114, or pieces of luggage 116 or 118 owned by a user 120. Using the RFID Device, unmarked and/or lost luggage can be identified and recovered using an RFID reader which reads the alphanumeric code which is associated with specific passenger contact information. The disclosed method should result in additional profit for airlines, as well as the benefit of a reduced number of lost luggage articles.

In the present example, the RFID Device may be freely purchased by the passenger for any type of luggage, for one-time use, or pre-paid for longer periods. For instance, in this example the passenger may purchase the RFID Device from the airline, or any other appropriate vendor. The purchase may be made (i) online at the time they purchase or reserve their ticket; (ii) through the airline or vendor's sales office; (iii) on the aircraft during the flight; or at any other appropriate time or location. Moreover, as will be apparent to one of ordinary skill in the art, while the following disclosure describes use of the RFID Device during air travel, the RFID Device may similarly be used on other transportation and/or logistics systems such as on rail systems, bus systems, cruise lines, etc.

Each example RFID Device, such as the RFID Devices 100, 102, 104, and 106 shown in FIG. 1, is associated with a unique identifier such as, for example, an alphanumeric code that is printed on, attached to, and/or encoded in the RFID Device. The disclosed system further comprises a database 122, which stores and tracks information relating to the RFID Devices 100, 102, 104, and 106 as well as information relating to system users, such as users 110, 114, and 120. For example, the disclosed system may contain information relating to (i) the status and location of RFID Devices (using, for example, the alphanumeric code associated with each RFID Device), and (ii) user account information, including identifying information, and any other appropriate information. Moreover, the database 122 tracks the relationship between user accounts and the RFID Devices—for example, a user may associate one or more RFID Devices to their user account after purchase, such as the user 120 that owns the piece of luggage 116 having one RFID Device 104 and the piece of luggage 118 having another RFID Device 106. The database 122 may be maintained online, as represented by an example online network 124 in FIG. 1, and/or at a physical location. The database may be operated by a company, airline, third party, etc., and the operator may designate certain employees who are granted access to the database information (referred to herein as “the Administrator”).

After purchasing the RFID Device, a user may register the RFID Device, thereby associating the RFID Device with his or her user account. Users may register their RFID Device online, via e-mail, via text messaging, telephonically, at designated kiosks, in-person, through written correspondence, and/or through any other appropriate communication method.

In order to match the RFID Device to a particular user, the user account on the database 122 contains certain personal identifying information. User accounts may be maintained on the database 122, and may be associated with one or more RFID Devices. Examples of identifying information include the user's name, phone number, address, contact information, travel itinerary, hotel accommodations, passport number, personal identification number, billing information, social networking information, etc. Users may enter as much or as little information depending on the user preference and/or the system preferences. For instance, users may not wish to enter confidential personal information because of security concerns. Still further the user may be able to enter temporary information and/or travel information as desired to ensure the RFID Device contains relevant data, in case of loss. The user may modify or add further identifying information at any time, including before and/or during a trip. Further, a user may register/associate a plurality of RFID devices to single user account.

Because of the range of the RFID Device, prior to the journey, the passenger may place the purchased and registered RFID Device inside the luggage, where the chip remains throughout the journey. The RFID Device may be placed inside the luggage by: (i) placing it into a special pocket or compartment; (ii) fastening it using a self-adhesive strip sold with the RFID Device; or any other suitable method which allows the placement and removal of the RFID Device. Afterwards, the RFID Device may be removed and used for a different journey and different article of luggage. The RFID Device may be single-use, pre-paid, for longer periods, and may be associated with various discounts, bonuses, etc.

In at least one example, the RFID Device should have a standard location in the luggage (e.g. near the handle) so as to facilitate the reading of the RFID code for lost luggage with the use of a reading device. During check-in, the passenger submits the luggage containing the RFID Device into the airline's luggage transport system. If the normal external identifier (usually a paper tag) is lost, then unmarked luggage is moved to the lost luggage department. There, an airline employee may scan the luggage using an RFID reading device. The RFID reading device locates the RFID Device inside the luggage and reads its alphanumeric code. This code will be entered into the database, either manually by an Administrator, or automatically through a processor connected to the RFID reading device.

As will be appreciated by one of ordinary skill in the art, the RFID reading device may be any suitable device capable of reading the electronically stored information of the RFID Device. For example, the RFID reading device may be stationary (i.e. attached to a larger apparatus), or handheld (i.e. a handheld scanner). In another example, the RFID reading device may be a feature on a multi-function device such as a barcode reader, a cellular phone, an x-ray scanner and or any other standard device located at an airport facility. Once the alphanumeric code is entered into the database 122, the database identifies the user associated with that RFID Device, and tracks the location of the luggage containing the RFID Device. For example, the Administrator or an appropriate airline employee may access the contact information for user account associated with the RFID Device and contact the user to arrange for delivery of the luggage.

Similarly, a user may track the location of the RFID Device using the system database 122, which tracks whether the RFID Device has been scanned by an RFID reading device, and where the RFID Device was last scanned by a system reading device. As illustrated in FIG. 1, the user may track the RFID Device using any appropriate means, such as via a computer system 126, an internet browser 128, a telephone 130, a mobile device (not shown), SMS messaging (not shown) and/or any other appropriate communication system (not shown). Additionally, the user may receive real-time alerts when the RFID Device is identified by an RFID reading device, including via email, SMS, automated telephone alerts, and/or any other appropriate communication means.

The disclosed system benefits the user by vastly decreasing the risk of luggage loss for a very small fee (i.e. the cost of the RFID Device). The disclosed system benefits the airlines by generating additional income from the sale of RFID Device at minimal expense (i.e. acquisition of handheld reading devices for the RFID chips), increasing customer satisfaction, and reducing expenses associated with both the storage and liquidation of lost unmarked luggage, and with insurance costs occurred compensating for damages caused by luggage loss. Additionally, the disclosed RFID system may further benefit airline carriers and operators because after a gradual introduction of the new RFID-based method, the disclosed method may replace the existing external tag marking method, thus reducing overall operational costs and increasing the efficiency of luggage sorting and checking.

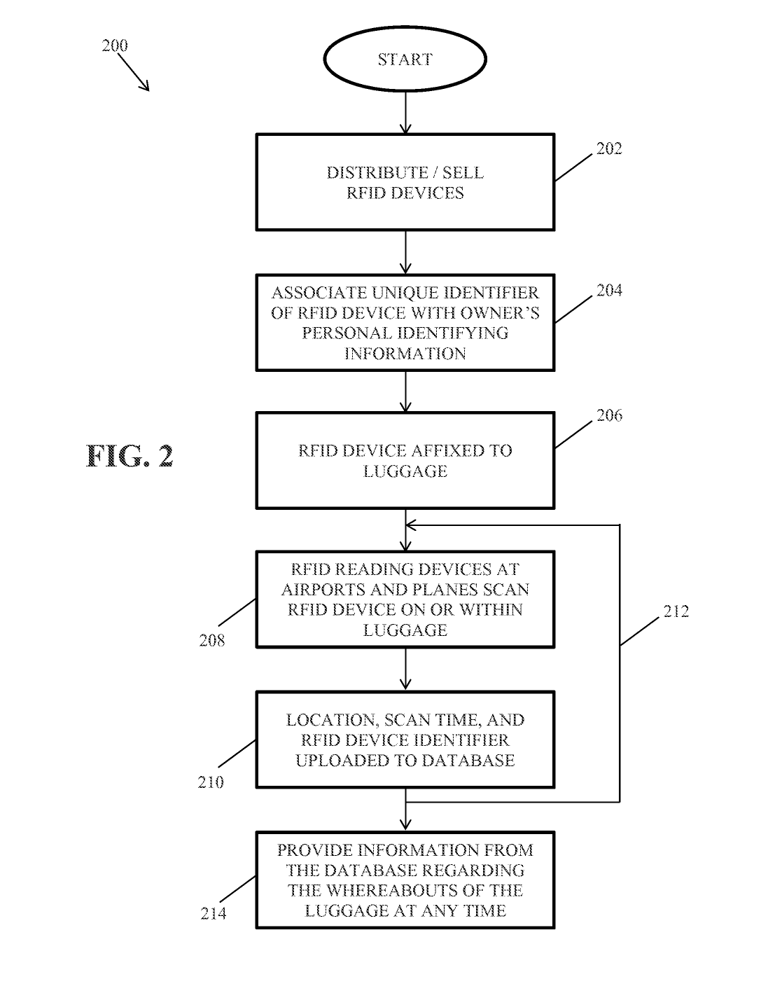

Though already disclosed above, an example method 200 of using the disclosed system is shown in a flowchart in FIG. 2. The example method 200 may begin with an airline, an airline vendor, or a third party selling and/or distributing RFID Devices to travelers, as represented at 202. The system may associate a unique identifier of an RFID Device that has been sold with personal identifying information provided by the owner of the RFID Device when the owner registers the RFID Device with the system, as represented at 204. The RFID Device may then be affixed to or within a piece of luggage, as represented at 206. When an owner of an RFID Device affixed to or within the piece of luggage proceeds to the airport, RFID reading devices at the airport and/or plane scan the RFID Device, as represented at 208. The time of the scan, the scan location, and the unique identifier of the RFID Device may be uploaded to the system database, as represented at 210. The RFID Device may be rescanned when moved to any subsequent checkpoint, and further information regarding the luggage's status may be uploaded to the database, as represented by 212. All the while, the system can provide information regarding the whereabouts of the luggage with the RFID Device in response to the owner's request, as shown at 214.

Those having ordinary skill in the art will understand that the disclosed example systems, apparatus, and methods are merely examples and that a multitude of variations to these examples systems, apparatus, and methods are contemplated by the present disclosure.

In still another aspect of the disclosure, an example system for tracking and identifying luggage may operate without an RFID or other wireless device. In essence, a unique identifier such as an alphanumeric code, for instance, can be disposed on an outside of a piece of luggage and used in the place of an RFID device.

In one example, passengers may visit an online interface or web portal where they can register for a unique identifier. The online interface may be accessed through any computer, tablet, or mobile device, for example. Passengers may then enter personal identifying information, to the extent they desire. For instance, some passengers may feel comfortable only entering an email address to be associated with the unique identifier. Others, though, may wish to enter much more, such as home and/or destination addresses, so that a lost piece of luggage may be shipped immediately without having to communicate through email.

Once registered, the example system may in one example generate a unique identifier for the registered passenger. In some examples of the disclosed system, the passenger is required to register first before generating the unique identifier. This requirement in turn prevents passengers from using unique identifiers without any associated personally identifiable information. Moreover, in some examples, the unique identifier is completely anonymous. This unique identifier may then be affixed to a piece of luggage so that the unique identifier is visible on an outside of the luggage. The unique identifier may be affixed to the piece of luggage in a wide variety of ways. By way of example, the unique identifier may be hand-written, painted, sprayed, stuck, laser engraved, embossed, or embroidered on the piece of luggage. In one example, the online interface may even provide a printable cut-out template that a registered passenger can use as an outline to spray paint the unique identifier onto the piece of luggage. In some examples, the unique identifier is affixed to the piece of luggage in a color that contrasts with a color of the piece of luggage.

Once the unique identifier is affixed to the piece of luggage, transportation providers (e.g., airlines) and entities that handle luggage (e.g., airport personnel) may use the unique identifiers on the luggage to track the whereabouts of the piece of luggage, as disclosed further above. The transportation providers and other entities may also use the unique identifier to identify the owner and proper destination of misplaced luggage. In the latter case, non-owners may access the online interface, enter the unique identifier, and view publicly accessible details provided by the owner. In some instances, details regarding personally identifiable information may not be publicly accessible, or may only be accessible to select organizations with preapproved permissions or those having a need to know.

Similar to other features disclosed above, passengers can update their information stored in the database at any point in time. This information may include, by example, dates and places of travel, flight numbers, and descriptions of luggage. Also, it should be understood that a unique identifier may be used on more than one piece of luggage. Conversely, it should also be understood that a passenger may generate more than one unique identifier, which may be advantageous where the passenger has more than one piece of luggage.

Yet further, those having ordinary skill in the art will recognize that many of the features disclosed with respect to the non-RFID Device system may be equally applicable to systems operating with RFID Devices. Likewise, many of the features disclosed with respect to systems using RFID Devices may be equally applicable to the aforementioned systems that do not utilize RFID Devices.

I claim:

1. A system for tracking and identifying luggage, the system comprising:
a radio frequency identification (RFID) device that is attachable to or insertable into a piece of luggage, the RFID device having a unique identifier associable with personal identifying information of an owner of the RFID device;
an RFID reader for determining the unique identifier of the RFID device at a location; and
a database for storing information associated with the RFID device, the information comprising the unique identifier and the location of the RFID device, wherein the database can be accessed to obtain the location of the RFID device.

2. The system of claim 1, wherein the unique identifier is an alphanumeric code that is at least one of printed on, attached to, or encoded in the RFID device.

3. The system of claim 1, wherein the database is maintained through at least one of a physical location or online.

4. The system of claim 1, wherein the RFID device is registrable through at least one of e-mail, an online interface, text messaging, telephonically, kiosks, in-person, or written correspondence.

5. The system of claim 1, wherein the database stores additional information including at least one of the following: a phone number of the owner of the RFID device, an email of the owner of the RFID device, one or more flight numbers for which the owner of the RFID device has a reservation, a passport number of the owner of the RFID device, or social networking information of the owner of the RFID device.

6. The system of claim 1, wherein the RFID device is attachable to or insertable into the piece of luggage by at least one of the following: placing the RFID device into a pocket or a compartment of the piece of luggage, or fastening the RFID device to the piece of luggage by way of a self-adhesive strip.

7. The system of claim 1, wherein the RFID device is disposable near a handle of the piece of luggage.

8. The system of claim 1, wherein the RFID reader includes a processor that automatically enters the unique identifier of the RFID device into the database.

9. The system of claim 1, wherein the RFID reader is a handheld device.

10. The system of claim 1, wherein an alert is sent through at least one of email, SMS, or telephone to the owner of the RFID device based on the location of the RFID device.

11. A system for tracking and identifying luggage, the system comprising:
a wireless device that is attachable to or insertable into a piece of luggage, the wireless device having a unique identifier associable with personal identifying information of an owner of the wireless device;
a reader for determining the unique identifier of the wireless device at a location, the wireless device and the reader communicating by a wireless communication protocol; and
a database for storing information associated with the wireless device, the information comprising the unique identifier and the location of the wireless device, wherein the database can be accessed to obtain the location of the wireless device.

12. The system of claim 11, wherein the wireless device and the reader communicate by way of at least one of radio frequency identification (RFID) or near field communication.

13. The system of claim 12, wherein the database stores additional information including at least one of the following: a phone number of the owner of the wireless device, an email of the owner of the wireless device, one or more flight numbers for which the owner of the wireless device has a reservation, a passport number of the owner of the wireless device, or social networking information of the owner of the wireless device.

14. The system of claim 12, wherein the reader includes a processor that automatically enters the unique identifier of the wireless device into the database.

15. The system of claim 12, wherein the reader is a handheld device.

16. The system of claim 12, wherein an alert is sent through at least one of email, SMS, or telephone to the owner of the wireless device based on the location of the wireless device.

17. A method for tracking and identifying luggage, the method comprising:
distributing at least one RFID device that is attachable to or insertable into a piece of luggage, the at least one RFID device having a unique identifier;
associating the unique identifier of the at least one RFID device with personal identifying information received from an owner of the at least one RFID device;
scanning the at least one RFID device with an RFID reader to determine the unique identifier of the at least one RFID device at a location;
storing information associated with the at least one RFID device to a database, the information comprising the unique identifier and the location of the at least one RFID device; and
providing the location of the at least one RFID device stored in the database upon request.

18. The method of claim 17, further comprising storing additional information in the database, the addition information including at least one of the following: a phone number of the owner of the at least one RFID device, an email of the owner of the at least one RFID device, one or more flight numbers for which the owner of the at least one RFID device has a reservation, a passport number of the owner of the at least one RFID device, or social networking information of the owner of the at least one RFID device.

19. The method of claim 17, further comprising sending an alert to the owner of the at least one RFID device based on the location of the at least one RFID device.

20. The method of claim 17, further comprising scanning the at least one RFID device with a second RFID reader to determine the unique identifier of the at least one RFID device at a second location.
